(19) United States
(12) Patent Application Publication
(10) Pub. No.: US 2006/0207830 A1
(43) Pub. Date: Sep. 21, 2006

(54) Non-self supporting portable ladder angle indicator

(76) Inventors: Ronald Gray, Rosemount, MN (US); Jerome Hamilton, Woodbury, MN (US)

Correspondence Address: RONALD GRAY, 4411 DERRYMOOR CT, ROSEMOUNT, MN, 55068, US

(21) Appl. No.: 11/084,782

(22) Filed: Mar. 21, 2005

(51) Int. Cl. E06C 5/44

(52) U.S. Cl. 182/18

(57) ABSTRACT

A bubble level designed to indicate the proper angle for use of Non-Self Supporting Portable Ladders is comprised of a housing (2) used to protect a bubble level (3) that will indicate when the proper angle is reached for safe use of the ladder as prescribed by OSHA Standard 1926.1053. The user will mount the device using a clamp (1) that can be rotated using the swivel hinge (5) over an 180° arc to locate the “Safe Use” indicator window at a 90° angle to the ladder side rail. The bubble level will be calibrated to indicate an angle of 78° from horizontal, the angle critical to the safety of the user. This device will provide a simple yet reliable indication of the safe use angle and can be carried by the user to mount on various ladders they may be working with or mounted permanently to all ladders considered for use.

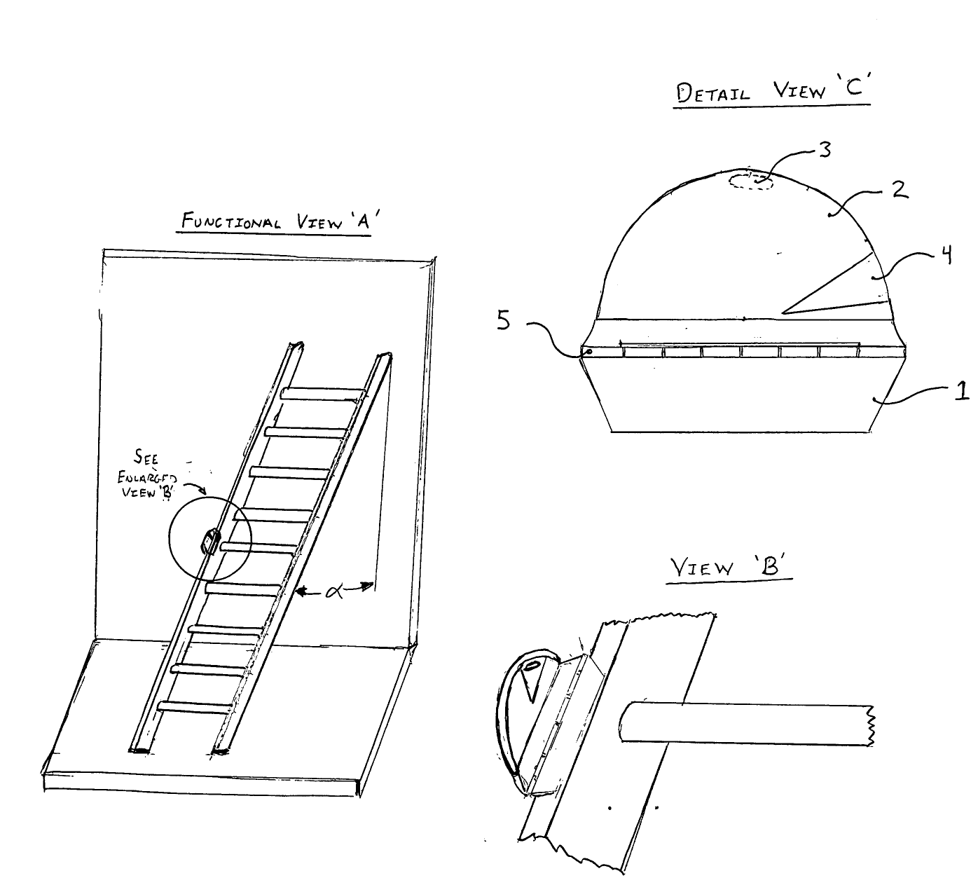

### BACKGROUND

1. Field of Invention

This invention relates to the providing indication of the proper angle for use of non-self supporting portable ladders in both residential and commercial/industrial applications.

2. Description of Prior Art

The proper placement of non-self supporting portable ladders requires the ladder be set-up at an angle critical to the safety of the user. This angle is referenced in the US Department of Labors Occupational Safety & Health Administration (OSHA) Standard 1926.1053 as “approximately one-quarter of the working length of the ladder”, or approximately 78° for horizontal.

Currently users of non-self supporting portable ladders have no device to assist them in setting up their ladder for safe use, the user is left to approximate the angle if they are even aware of the OSHA requirements.

### OBJECTS AND ADVANTAGES

Accordingly, several objects and advantages of the Non-Self Supporting Portable Ladder Angle Indicator are:

(a) Allow user to place ladder at the OSHA recommended safe angle for use to prevent the bottom of the ladder from sliding.

(b) Allow user to place ladder at the OSHA identified angle for maximum load capability as tested by the manufacturer.

(c) In commercial or industrial applications allows company owners or management a device to ensue employees follow recommended safety procedures.

(d) Reduces companies or corporations potential for fines or other regulatory issues due to injury of employees from improper use of ladders

Still Further objects and advantages will become apparent from a consideration of the ensuing description and drawings.

### REFERENCE NUMERALS IN DRAWINGS

1 adjustable mounting clamp
2 housing
3 bubble level
4 “Safe Use” window
5 swivel hinge

### SUMMARY

In accordance with the present invention a Non-Self Supporting Portable Ladder Angle Indicator comprises an adjustable mounting device for attachment to a ladder side rails and integral bubble level marked to indicate the OSHA recommended angle for use.

### OPERATION

The manner of using the Non-Self Supporting Portable Ladder Angle Indicator requires that the user first mount the device to the ladder side rail using the adjustable mounting clamp (1). The clamp is capable or rotating 180° around the swivel hinge (5) to allow mounting to ladders with “C” channel or straight edge side rails. The user will then place the ladder against the surface they are to climb. The user will then adjust the ladder angle until the bubble on the bubble level (3) falls within the marked “Safe Use” window (4) markings on the device. The level housing (2) will protect the level from damage during use or storage.

Once the ladder has been adjusted to the prescribed OSHA “Safe Use” angles, the user can then proceed with using the ladder while following the manufacturers guidelines for use.

Upon completion of use, the user will then remove the level device and store for future applications.

### CONCLUSION, RAMIFICATIONS AND SCOPE

Accordingly, the reader will see that the Non-Self Supporting Portable Ladder Angle Indicator will allow use on nearly any type of ladder to indicate the safe angle for use.

Although the description above contains much specificity, these should not be construed as limiting the scope of the invention but merely providing illustrations of some of the presently preferred embodiments of this invention.

I claim:

1. A method for the indicating the proper angle for the safe use of Non-Self Supporting Portable Ladders:
(a) providing a visual indication of proper angle as described by OSHA
(b) providing a means for attachment to a Non-Self Supporting Portable Ladder
(c) providing a means for OEM's to mount permanently to ladders
